(19) United States
(12) Patent Application Publication
(10) Pub. No.: US 2014/0123649 A1
(43) Pub. Date: May 8, 2014

(54) ACOUSTIC DAMPING SYSTEM FOR A COMBUSTOR OF A GAS TURBINE ENGINE

(71) Applicants: JUAN E. PORTILLO BILBAO, OVIEDO, FL (US); RAJESH RAJARAM, OVIEDO, FL (US); DANNING YOU, OVIEDO, FL (US)

(72) Inventors: JUAN E. PORTILLO BILBAO, OVIEDO, FL (US); RAJESH RAJARAM, OVIEDO, FL (US); DANNING YOU, OVIEDO, FL (US)

(21) Appl. No.: 13/670,564

(22) Filed: Nov. 7, 2012

(51) Int. Cl. F02C 7/24; F01N 1/00

(52) U.S. Cl. CPC F02C 7/24; F01N 1/00
USPC 60/725; 181/212

(57) ABSTRACT

An acoustically dampened gas turbine engine having a combustor with an acoustic damping system is disclosed. The acoustic damping system may be formed from an acoustic damping body having at least one orifice configured to receive a combustor nozzle assembly. The acoustic damping body may be positioned in a head region of a combustor basket and may include one or more orifices in the acoustic damping body. The acoustic damping system may mitigate longitudinal mode dynamics thereby increasing an engine operating envelope and decreasing emissions.

### FIELD OF THE INVENTION

The present invention relates in general to gas turbine engines and, more particularly, to acoustic damping systems for damping longitudinal mode dynamics in combustor baskets in gas turbine engines.

### BACKGROUND OF THE INVENTION

Gas turbine engines typically include a plurality of combustor baskets positioned downstream from a compressor and upstream from a turbine assembly. During operation, longitudinal mode dynamics often occurs in the combustor baskets, as shown in FIGS. 1-3. The longitudinal mode dynamics usually originates at the inlet of the air flow path in a combustor basket and travels downstream to the turbine inlet. The dynamics restrict the tuning flexibility of the gas turbine engine in order to operate at lower emissions, which is an ever increasing requirement for newer gas turbines.

### SUMMARY OF THE INVENTION

Set forth below is a brief summary of the invention that solves the foregoing problems and provides benefits and advantages in accordance with the purposes of the present invention as embodied and broadly described herein. This invention is directed to an improved gas turbine engine having a combustor with an acoustic damping system. The acoustic damping system may mitigate longitudinal mode dynamics, thereby increasing an engine operating envelope and indirectly assist in decreasing emissions. The acoustic damping system may be formed from an acoustic damping body having at least one orifice configured to receive a combustor nozzle assembly. The acoustic damping body may be positioned in a head region of a combustor basket and may include one or more orifices in the acoustic damping body.

The acoustic damping system may be formed from an acoustic damping body having at least one orifice configured to receive a combustor nozzle assembly. In one embodiment, the at least one orifice configured to receive a combustor nozzle assembly acoustic damping system may be formed from at least one center orifice configured to receive a combustor nozzle assembly. The acoustic damping body may be formed from a material shaped in a flat plane having an upstream side and a downstream side that have the inner and outer edges extending therebetween. The inner and outer edges may have any appropriate configuration, such as, but not limited to, generally cylindrical.

The acoustic damping body may include at least one orifice in the acoustic damping body and positioned between an inner edge defining the center orifice and an outer edge of the acoustic damping body. In at least one embodiment, the orifice in the acoustic damping body is actually a plurality of orifices in the acoustic damping body. The plurality of orifices in the acoustic damping body may be formed from an inner ring of orifices and an outer ring of orifices. The inner ring of orifices and the outer ring of orifices may be concentric. The inner ring of orifices and the outer ring of orifices may be concentric with the center orifice. In at least one embodiment, the plurality of orifices in the acoustic damping body may all be formed from orifices having a single size. In at least another embodiment, a portion of the plurality of orifices in the acoustic damping body may be formed from orifices having a first size and a portion of the plurality of orifices in the acoustic damping body may be formed from orifices having a second size that is larger than the first size. One or more of the orifices may be cylindrical in shape.

In another embodiment, the acoustic damping body may include a downstream side extending from an outer edge of the acoustic damping body to an upstream side at an inner edge and may be positioned at an acute angle relative to a longitudinal axis. The acoustic damping body may be generally linear. The acoustic damping body may include a plurality of orifices in the downstream side that do not extend completely through the acoustic damping body.

In yet another embodiment, the acoustic damping body may include a downstream side extending from an outer edge of the acoustic damping body to an upstream side at an inner edge and may be positioned at an acute angle relative to a longitudinal axis. The acoustic damping body may be generally curved. The acoustic damping body may include a plurality of orifices in the downstream side that do not extend completely through the acoustic damping body.

During use, the acoustic damping system may dampen the longitudinal mode combustor dynamics, thereby permitting the gas turbine engine operating envelope to be increased. The acoustic damping system may function as a flow conditioner by creating a more uniform flow at the head end and by creating better mixing downstream.

These and other advantages and objects will become apparent upon review of the detailed description of the invention set forth below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is cross-sectional side view of a conventional combustor basket of a gas turbine engine.

FIG. 2 is a prior art graph of longitudinal mode dynamics of dynamic pressure versus frequency.

FIG. 3 is a prior art graph of the longitudinal mode shape of dynamic pressure versus location in a combustor basket.

FIG. 4 is a cross-sectional side view of a combustor basket of a gas turbine engine.

FIG. 5 is a partial cross-sectional side view of an acoustic damping system positioned within the combustor basket taken at detail 5 in FIG. 4.

FIG. 6 is an end view of the acoustic damping system of FIG. 5.

FIG. 7 is a partial cross-sectional side view of another embodiment of the acoustic damping system positioned within the combustor basket taken at detail 7 in FIG. 4.

FIG. 8 is an end view of the acoustic damping system of FIG. 7.

FIG. 9 is a partial cross-sectional side view of yet another embodiment of the acoustic damping system positioned within the combustor basket taken at detail 9 in FIG. 4.

FIG. 10 is a detailed side view of the acoustic damping system taken at detail 11 in FIG. 9.

FIG. 11 is a detailed side view of the acoustic damping system taken at detail 11 in FIG. 9.

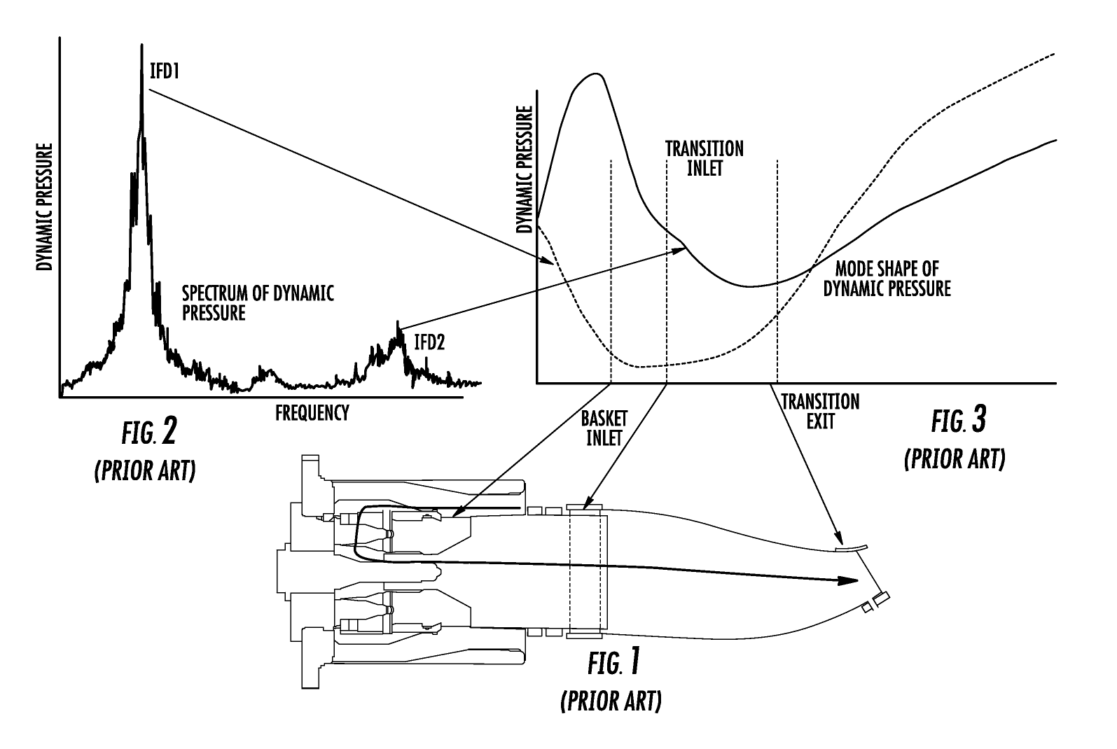

### DETAILED DESCRIPTION OF THE INVENTION

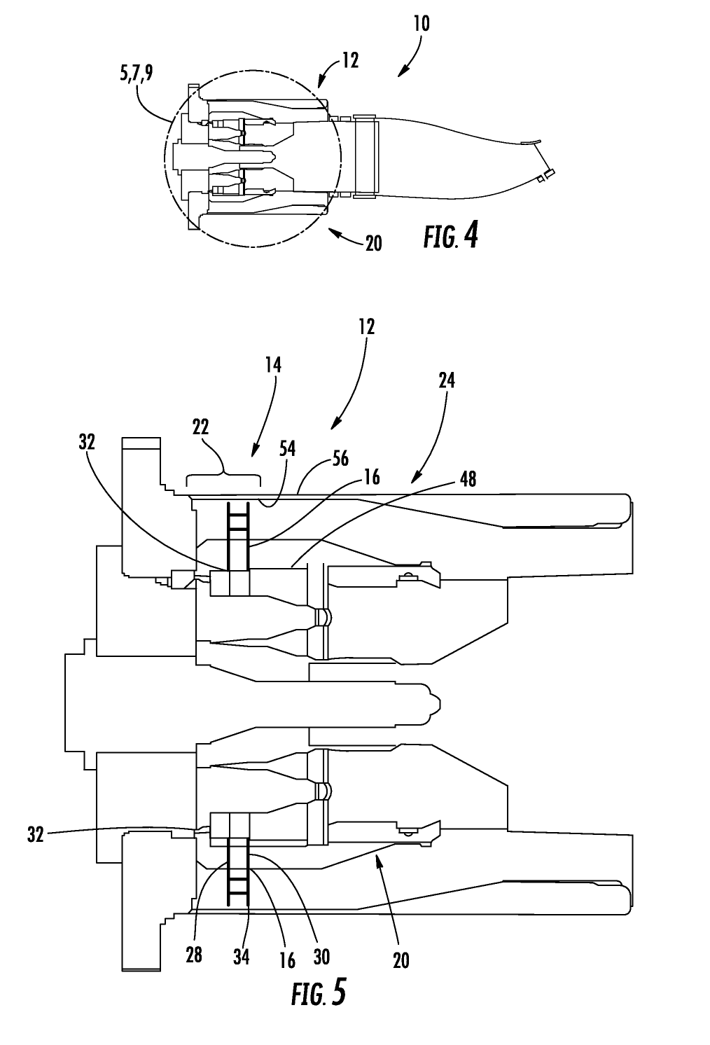

As shown in FIGS. 4-11, this invention is directed to an acoustically dampened gas turbine engine 10 having a combustor 12 with an acoustic damping system 14. The acoustic damping system 14 may be formed from an acoustic damping body 16 having at least one orifice 18 configured to receive a combustor nozzle assembly 20. The acoustic damping body 16 may be positioned in a head region 22 of a combustor basket 24 and may include one or more orifices 26 in the acoustic damping body 16. The acoustic damping system 14 may mitigate longitudinal mode dynamics, thereby increasing an engine operating envelope and indirectly help decreasing emissions.

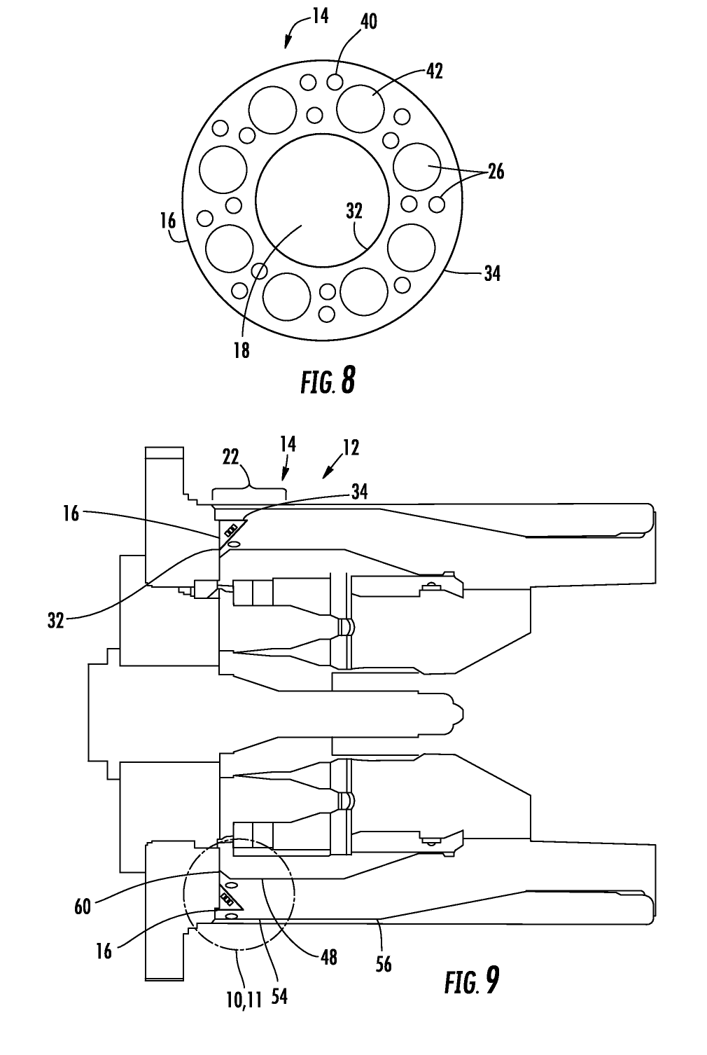

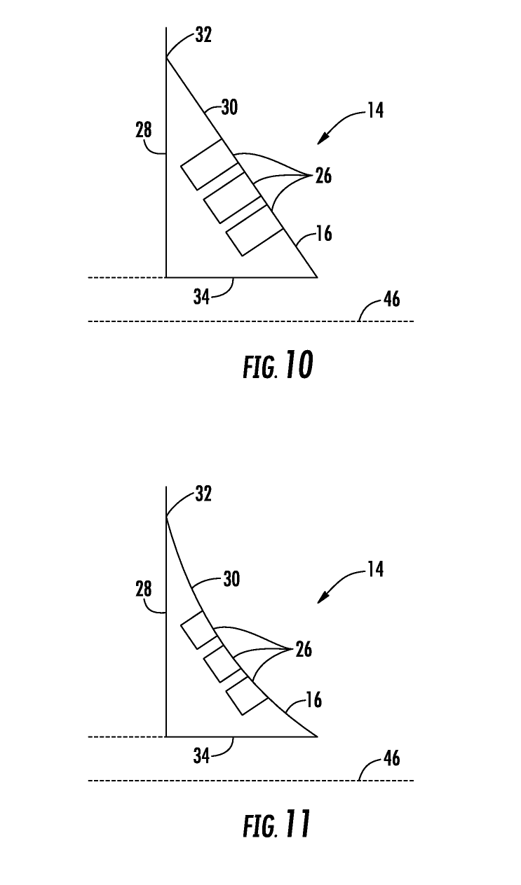

The acoustic damping system 14 may be configured to fit within the head region 22 in the combustor basket 12 of the gas turbine engine 10. The acoustic damping system 14 may include an acoustic damping body 16 with one or more orifices 18. The orifice 18 may be positioned in any appropriate position within the acoustic damping body 16. In at least one embodiment, the orifice 18 positioned within the acoustic damping body 18 is a center orifice 18. The center orifice 18 may be generally cylindrical or may have another appropriate shape configured to fit radially outward of and around the combustor nozzle assembly 20. In one embodiment, as shown in FIG. 5, the center orifice 18 may be sized to fit around a combustor inlet 48. In another embodiment, as shown in FIG. 7, the center orifice 18 may be sized to fit around fuel nozzles 50. In another embodiment, as shown in FIG. 9, the center orifice 18 may be sized to fit around the combustor inlet 48.

The acoustic damping body 16 may be formed from a material shaped in a flat plane having an upstream side 30 and a downstream side 28 that have the inner and outer edges 32, 34, extending therebetween. The inner edge 32 may define the center orifice 18 and be configured as set forth above. The outer edge 34 may have any appropriate configuration, and, in at least one embodiment, may be generally cylindrical. The outer edge 34 of the embodiment shown in FIG. 5 may be sized to contact an inner surface 54 of a combustor case 56. The outer edge 34 of the embodiment shown in FIG. 7 may be sized to fit within the combustor inlet 48, and may contact an inner surface 58 of the combustor inlet 48. The outer edge 34 of the embodiment shown in FIG. 9 may be sized to fit against a head wall 60 between the combustor inlet 48 and the inner surface 54 of the combustor case 56.

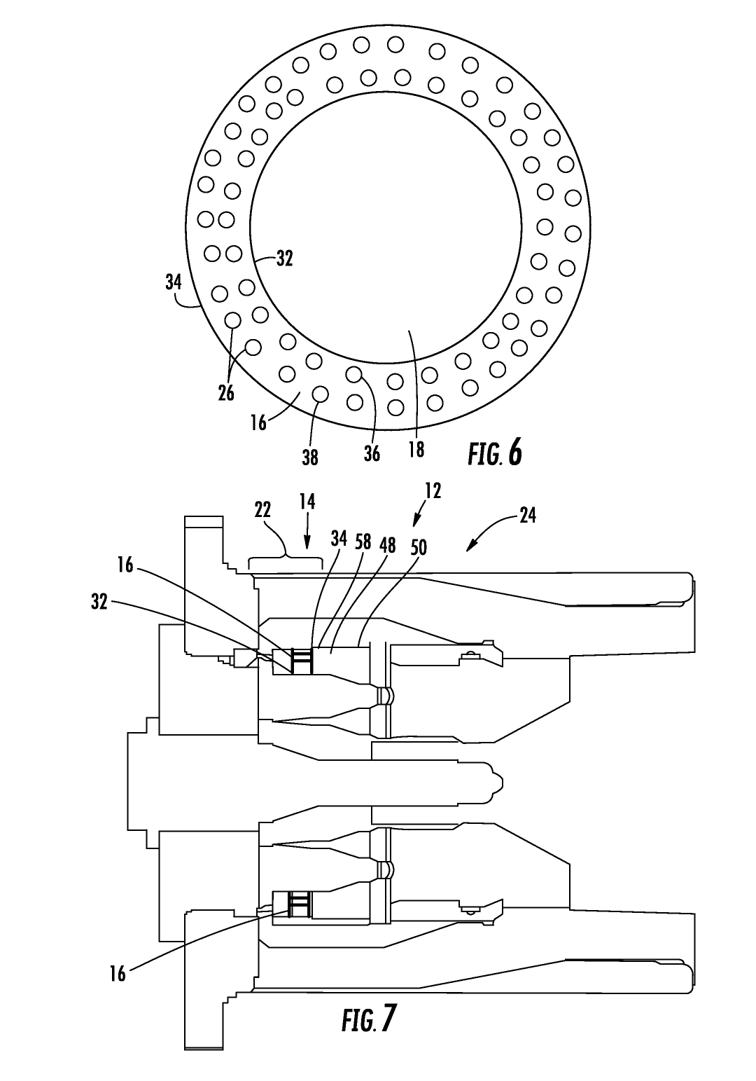

The acoustic damping body 16 may also include one or more orifices 26 that may be positioned between the inner edge 32 defining the center orifice 18 and the outer edge 34. The orifices 26 may have any appropriate shape, such as, but not limited to, cylindrical. As shown in FIGS. 6 and 8, the acoustic damping body 16 may include a plurality of orifices 26 in the acoustic damping body 16. The orifices 26 may each be configured identically, each configured differently, or with multiple different configurations. In one embodiment, the plurality of orifices 26 in the acoustic damping body 16 may be formed from an inner ring 36 of orifices 26 and an outer ring 38 of orifices 26. The inner ring 36 of orifices 26 and the outer ring 38 of orifices 26 may be concentric with each other. In addition, the inner ring 36 of orifices 26 and the outer ring 38 of orifices 26 may be concentric with the center orifice 18. The orifices 26 in the acoustic damping body 16, as shown in FIG. 6, may be all formed from orifices having a single size. In another embodiment, as shown in FIG. 8, a first portion 40 of the plurality of orifices 26 in the acoustic damping body 16 may be formed from orifices 26 having a first size and a second portion 42 of the plurality of orifices 26 in the acoustic damping body 16 may be formed from orifices 26 having a second size that is larger than the first size.

In another embodiment, as shown in FIGS. 9-10, the acoustic damping body 16 may include an aerodynamically determined upstream side 30, such as a conically shaped upstream side 30. As shown in cross-section, the upstream side 30 may extend from an outer edge 32 of the acoustic damping body 16 to an downstream side 28 at an inner edge 32 and may be positioned at an acute angle relative to a longitudinal axis 46. The acoustic damping body 16 may also include a plurality of orifices 26 that may extend into the body 16 but not through the body 16 or may protrude into the flow path.

In yet another embodiment, as shown in FIG. 11, the acoustic damping body 16 may include an aerodynamically determined upstream side 30, such as a conically shaped upstream side 30. As shown in cross-section, the upstream side 30 may extend from an outer edge 32 of the acoustic damping body 16 to an downstream side 28 at an inner edge 32 and may be positioned at an acute angle relative to a longitudinal axis 46. The acoustic damping body 16 may be generally curved. The acoustic damping body 16 may also include a plurality of orifices 26 that may extend into the body 16 but not through the body 16 or may protrude into the flow path.

During use, the acoustic damping system 14 may dampen the longitudinal mode combustion dynamics, thereby permitting the turbine engine operating envelope to be increased. The acoustic damping system 14 may function as a flow conditioner by creating a more uniform flow at the combustor inlet 48 and by creating better mixing profile downstream.

The foregoing is provided for purposes of illustrating, explaining, and describing embodiments of this invention. Modifications and adaptations to these embodiments will be apparent to those skilled in the art and may be made without departing from the scope or spirit of this invention or the following claims.

We claim:

1. An acoustic damping system for a combustor of a gas turbine engine, comprising:
an acoustic damping body having at least one orifice configured to receive a combustor nozzle assembly; and
at least one orifice in the acoustic damping body and positioned between an inner edge defining the at least one orifice and an outer edge of the acoustic damping body.

2. The acoustic damping system of claim 1, wherein the acoustic damping body is formed from a material shaped in a flat plane having an upstream side and a downstream side that have the inner and outer edges extending therebetween.

3. The acoustic damping system of claim 1, wherein the outer edge is generally cylindrical.

4. The acoustic damping system of claim 1, wherein the at least one orifice in the acoustic damping body comprises a plurality of orifices in the acoustic damping body.

5. The acoustic damping system of claim 4, wherein the plurality of orifices in the acoustic damping body are formed from an inner ring of orifices and an outer ring of orifices.

6. The acoustic damping system of claim 5, wherein the inner ring of orifices and an outer ring of orifices are concentric.

7. The acoustic damping system of claim 5, wherein the acoustic damping body having at least one orifice configured to receive a combustor nozzle assembly comprises at least one center orifice configured to receive a combustor nozzle assembly.

8. The acoustic damping system of claim 7, wherein the inner ring of orifices and an outer ring of orifices are concentric with the at least one center orifice.

9. The acoustic damping system of claim 4, wherein the plurality of orifices in the acoustic damping body are all formed from orifices having a single size.

10. The acoustic damping system of claim 4, wherein a portion of the plurality of orifices in the acoustic damping body are formed from orifices having a first size and a portion of the plurality of orifices in the acoustic damping body are formed from orifices having a second size that is larger than the first size.

11. The acoustic damping system of claim 4, wherein at least one orifice of the plurality of orifices is cylindrical in shape.

12. The acoustic damping system of claim 1, wherein a downstream side extending from an outer edge of the acoustic damping body to an upstream side at an inner edge is positioned at an acute angle relative to a longitudinal axis.

13. The acoustic damping system of claim 12, wherein the acoustic damping body is generally curved.

14. The acoustic damping system of claim 12, further comprising a plurality of orifices in the downstream side that do not extend completely through the acoustic damping body.

15. An acoustic damping system for a combustor of a gas turbine engine, comprising:
an acoustic damping body having at least one orifice configured to receive a combustor nozzle assembly;
a plurality of orifices in the acoustic damping body and positioned between an inner edge defining the at least one orifice and an outer, generally cylindrical edge of the acoustic damping body; and
wherein the acoustic damping body is formed from a material shaped in a flat plane having an upstream side and a downstream side that have the inner and outer edges extending therebetween.

16. The acoustic damping system of claim 15, wherein the at least one orifice configured to receive a combustor nozzle assembly comprises at least one center orifice configured to receive a combustor nozzle assembly, and wherein the plurality of orifices in the acoustic damping body are formed from an inner ring of orifices and an outer ring of orifices and wherein at least one orifice of the plurality of orifices is cylindrical in shape.

17. The acoustic damping system of claim 16, wherein the inner ring of orifices and an outer ring of orifices are concentric with each other and are concentric with the at least one center orifice.

18. The acoustic damping system of claim 15, wherein the plurality of orifices in the acoustic damping body are all formed from orifices having a single size.

19. The acoustic damping system of claim 15, wherein a portion of the plurality of orifices in the acoustic damping body are formed from orifices having a first size and a portion of the plurality of orifices in the acoustic damping body are formed from orifices having a second size that is larger than the first size, and wherein a downstream side extending from an outer edge of the acoustic damping body to an upstream side at an inner edge is positioned at an acute angle relative to a longitudinal axis.

20. An acoustically damped gas turbine engine, comprising:
a combustor basket having at least one nozzle assembly and an acoustic damping system positioned at a head end region of the combustor basket surrounding the nozzle assembly;
wherein the acoustic damping system comprises
an acoustic damping body having at least one center orifice configured to receive a combustor nozzle assembly; and
at least one orifice in the acoustic damping body and positioned between an inner edge defining the at least one center orifice and an outer edge of the acoustic damping body.
